(19) United States
(12) Patent Application Publication
(10) Pub. No.: US 2026/0286603 A1
(43) Pub. Date: Sep. 24, 2026

(54) METHOD OF PRODUCING THERMAL TRANSFER PRINT SHEET, THERMAL TRANSFER PRINT SHEET, AND METHOD OF THERMAL TRANSFER PRINTING

(71) Applicants: Katsunori KUROSE, Shizuoka (JP); Kazumi SUZUKI, Shizuoka (JP); Toyoshi SAWADA, Shizuoka (JP)

(72) Inventors: Katsunori KUROSE, Shizuoka (JP); Kazumi SUZUKI, Shizuoka (JP); Toyoshi SAWADA, Shizuoka (JP)

(21) Appl. No.: 19/554,894

(22) Filed: Mar. 3, 2026

(30) Foreign Application Priority Data
Mar. 18, 2025 (JP) 2025-043780

(51) Int. Cl. D06P 5/24; B41M 5/025; B41M 5/44; B41M 5/46; D06P 1/52; D06P 1/673

(52) U.S. Cl. CPC D06P 5/009; B41M 5/0256; B41M 5/44; B41M 5/465; D06P 1/5271; D06P 1/673; B41M 2205/02; B41M 2205/30; B41M 2205/40

(57) ABSTRACT

A method of producing a thermal transfer print sheet includes forming, on a transfer sheet, a clear layer having a thickness of at least 5 μm with a clear toner containing a thermoplastic elastomer and polyester, forming, on the clear layer, an image layer containing a colorant, and forming, on the image layer, an adhesive layer thicker than the clear layer with a black toner containing a thermoplastic elastomer, polyester, and carbon black and having a volume average particle diameter of 9 to 30 μm or a white toner containing a thermoplastic elastomer, polyester, and a white pigment and having a volume average particle diameter of 9 to 30 μm.

### CROSS-REFERENCE TO RELATED APPLICATIONS

This patent application is based on and claims priority pursuant to 35 U.S.C. § 119 to Japanese Patent Application No. 2025-043780 filed on Mar. 18, 2025, in the Japan Patent Office, the entire disclosure of which is hereby incorporated by reference herein.

### BACKGROUND

### Technical Field

The present disclosure is related to a method of producing a thermal transfer print sheet, a thermal transfer print sheet, and a method of thermal transfer printing.

### Description of the Related Art

Electrophotography is a method of developing an electrostatic latent image with a developing composition to render the electrostatic latent image visible and forms an electrostatic latent image on an electrostatic latent image bearer (hereinafter also referred to as a photoconductor) containing a photoconductive material, developing the electrostatic latent image with a developing composition containing toner to obtain a toner image, transferring the toner image onto a transfer material, typically paper, and fixing the toner image by applying heat and pressure to obtain a fixed image.

To form a full color image by electrophotography, a toner set of three process colors (also referred to as simply process colors) of cyan toner, magenta toner, and yellow toner combined with black toner is used in general.

Currently, electrophotographic color image forming apparatuses become popular and produce printed matter with various applications. For a sector of consumable goods made to order, electrophotographic printing is highly expected to support a material on which traditional electrophotographic toner for paper media is not printable or fixable. Specifically, the need for printing on fabrics such as uniforms, shoes, and bags for a sports team is increasing.

### SUMMARY

The present disclosure described herein provides a method of producing a thermal transfer print sheet which includes forming, on a transfer sheet, a clear layer having a thickness of at least 5 μm with a clear toner containing a thermoplastic elastomer and polyester, forming, on the clear layer, an image layer containing a colorant, and forming, on the image layer, an adhesive layer thicker than the clear layer with a black toner containing a thermoplastic elastomer, polyester, and carbon black and having a volume average particle diameter of 9 to 30 μm or a white toner containing a thermoplastic elastomer, polyester, and a white pigment and having a volume average particle diameter of 9 to 30 μm.

As another aspect of the present disclosure, a thermal transfer print sheet is provided which includes a transfer sheet, a clear layer on the transfer sheet, the clear layer having a thickness of at least 5 μm and containing a thermoplastic elastomer and a polyester, an image layer on the clear layer, the image layer containing a colorant, and an adhesive layer on the image layer, the adhesive layer being thicker than the clear layer and containing a black toner containing a thermoplastic elastomer, a polyester, and a carbon black or a white toner containing a thermoplastic elastomer, a polyester, and a white pigment.

As another aspect of the present disclosure, a method of thermal transfer printing is provided which includes stacking the thermal transfer print sheet of claim 4 on a transfer medium with the adhesive layer facing the transfer sheet, heating and pressing the thermal transfer print sheet with a heat pressing machine, cooling the thermal transfer print sheet and peeling off the transfer sheet to thermally-transfer the adhesive layer, the image layer, and the clear layer to the transfer medium.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a schematic diagram illustrating an example of the image forming apparatus according to an embodiment of the present disclosure;

FIG. 2 is a schematic diagram illustrating the image forming apparatus according to another embodiment of the present disclosure;

FIG. 3 is a schematic diagram illustrating another example of the image forming apparatus according to the present disclosure;

FIG. 4 is a partially enlarged diagram illustrating the diagram illustrated in FIG. 3;

FIG. 5 is a schematic diagram illustrating an example of a process cartridge;

FIG. 6 is a diagram illustrating a diagram for explaining a method of thermal transfer printing on a transfer medium using a thermal transfer print sheet; and

FIG. 7 is a diagram illustrating an example of a grey scale for staining.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

The present disclosure provides a method of producing a thermal transfer print sheet that allows highly reproducible images to be firmly fixed, with excellent flexibility and rubbing fastness, even on flexible recording materials having pronounced surface irregularities, such as fabrics and leather, for which conventional toners have difficulty achieving adequate fixation, and that also prevents any reduction in chroma or brightness even on dark-colored recording materials.

Below is the description of the thermal transfer print sheet.

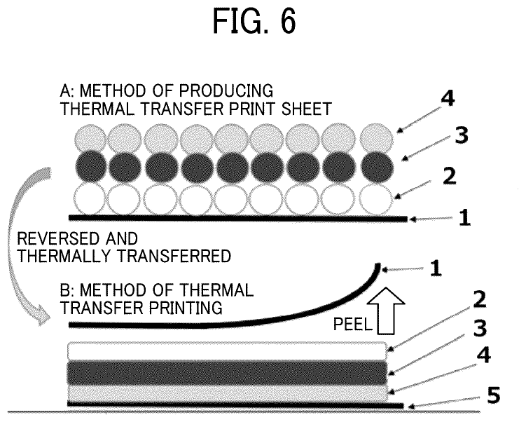

FIG. 6 is a diagram illustrating a diagram for explaining a method of thermal transfer printing on a transfer medium using a thermal transfer print sheet.

As illustrated in “A: METHOD OF PRODUCING THERMAL TRANSFER PRINT SHEET” in FIG. 6, a clear layer 2 as a release layer is formed on a transfer sheet (printing medium) 1, an image layer 3 as a color image layer is then formed on the clear layer 2, and an adhesive layer 4 is subsequently formed on the image layer 3, thereby producing a thermal transfer print sheet.

As illustrated in “B: METHOD OF THERMAL TRANSFER PRINTING” in FIG. 6, the thermal transfer print sheet obtained in this manner is pressed against a transfer medium 5 such that the adhesive layer 4 faces the surface of the transfer target material 5, and the sheet is heated and pressed using a heat press machine. After cooling, the transfer sheet 1 is peeled off, thereby thermally transferring the adhesive layer 4, the image layer 3, and the clear layer 2 of the thermal transfer print sheet onto the transfer medium 5.

The method of producing thermal transfer print sheet of the present disclosure includes the following steps (a) to (c):
(a) forming a clear layer having a thickness of at least 5 μm on a transfer sheet;
(b) forming an image layer containing a colorant on the clear layer; and
(c) forming an adhesive layer on the image layer.

In step (a), a clear layer having a thickness of at least 5 μm is formed using a clear toner containing at least a thermoplastic elastomer and a polyester.

In step (b), an image layer containing a colorant is formed.

In step (c), the adhesive layer is formed using either a black toner containing at least a thermoplastic elastomer, a polyester, and carbon black, or a white toner containing at least a thermoplastic elastomer, a polyester, and a white pigment.

According to the method of producing the thermal transfer print sheet of the present disclosure, a thermal transfer print sheet is provided which includes a transfer sheet, a clear layer on the transfer sheet having a thickness of at least 5 μm, the clear layer containing a thermoplastic elastomer and a polyester, an image layer on the clear layer, the image layer containing a colorant; an adhesive layer on the image layer, the adhesive layer containing a black toner containing a thermoplastic elastomer, a polyester, and a carbon black or a white toner containing a thermoplastic elastomer, a polyester, and a white pigment.

The present disclosure is detailed below.

First, the resin toner for use in the present disclosure is described.

### Clear Toner

The clear toner is used to form the clear layer that is in contact with the transfer sheet, and contains a thermoplastic elastomer and a polyester. It is preferable to use a clear toner having a transmittance of at least 70 percent over the entire visible light wavelength range in a solid image having a deposition amount of 30 mg/cm².

### Color Ink or Color Toner

The color ink or color toner is used to form the image layer that is placed between the clear layer and the adhesive layer.

### Black Toner

The black toner is used to form the adhesive layer (concealing layer) that adheres to the transfer medium, and contains a thermoplastic elastomer, a polyester, and a carbon black. It is preferable to use a black toner having a transmittance of less than 1 percent over the entire visible light wavelength range in a solid image having a deposition amount of 30 mg/cm².

To reduce the transmittance of the black toner to less than 1 percent, the toner preferably contains a black pigment that fully absorbs wavelengths in the visible light region.

### White Toner

The white toner is used to form the adhesive layer that adheres to the transfer medium, and contains a thermoplastic elastomer, a polyester, and a white pigment. It is preferable to use a white toner having a transmittance of less than 1 percent over the entire visible light wavelength range in a solid image having a deposition amount of 30 mg/cm².

To reduce the transmittance of the white toner to less than 1 percent, the toner preferably contains a white pigment that fully reflects/scatters visible light.

### Toner Particle Diameter

It is preferable to use toner having a volume average particle diameter of 9 to 30 μm to produce the thermal transfer print sheet.

### White Pigment

There is no particular limitation on the white pigment used in the present disclosure, and it may be appropriately selected according to a particular application. Specific examples include, but are not limited to, titanium dioxide, lead white, talc, kaolin, zinc sulfide, barium sulfate, calcium carbonate, zinc oxide, and hollow silica.

Further, a white pigment surface treated with a substance such as a silicon compound, a zirconia compound, an aluminum compound, and an organic substance such as a polyol may be used.

Preferably, titanium dioxide surface-treated with an aluminum compound and/or an organic substance such as a polyol is used. It is presumed that, due to the surface treatment, a release agent in the toner wets the white pigment, so that a white concealing layer is formed which reduces the hardness of the toner layer and makes it less prone to cracking.

The content of the white pigment in the toner varies depending on the type of pigment, but is preferably 20 to 50 percent by mass, and more preferably 20 to 40 percent.

When the content of the white pigment is at least 20 percent by mass, excellent concealing power is achieved, preventing the design of the transfer medium from showing through, and thus preventing a decrease in image saturation or brightness. When the content of the white pigment is at most 50 percent by mass, flexibility can be maintained and cracking does not occur in the toner layer formed on a flexible transfer medium.

### Black Pigment

There is no particular limitation on the black pigment used in the present disclosure, and it may be appropriately selected according to a particular application. However, carbon black alone, or a mixture of carbon black as the main component with a substance such as copper phthalocyanine for adjusting hue and brightness, is preferred.

When carbon black is used, the appropriate toner content is 4 to 10 percent by mass.

When the carbon black content is at least 4 percent by mass, excellent concealing power is obtained, preventing the design of the transfer medium from showing through. When the carbon black content is at most mass 10 percent by mass, the volume resistivity of the toner does not decrease and the charging performance remain impaired.

### Colorant

Color toners or color inks having chromatic colors may be used in addition to the clear toner, white toner, and black toner for use in the present disclosure. There is no particular limitation on the colorant, and any colorant commonly used in the art may be appropriately selected and employed.

Preferably, the colorant exhibits low absorption at wavelengths of at least 800 nm.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, dioxane violet, Anthraquinone Violet, Chrome Green, zinc green, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, perylene black, and mixtures thereof. These can be used alone or in combination.

The polyester for use in the toner for producing a thermal transfer print sheet is preferably obtained by polycondensation of an alcohol component with a carboxylic acid component. The alcohol components to be used are not particularly limited and can be suitably selected according to a particular application.

Specific examples include, but are not limited to, glycols such as ethylene glycol, diethylene glycol, triethylene glycol, and propylene glycol, 1,4-bis(hydroxymethyl)cyclohexane, etherified bisphenols such as bisphenol A, diol monomers, tri- or higher polyol monomers.

The carboxylic acid components to be used are not particularly limited and can be suitably selected according to a particular application. Specific examples include, but are not limited to, two-valent organic acid monomers such as maleic acid, fumaric acid, phthalic acid, isophthalic acid, terephthalic acid, succinic acid, and moronic acid; and tri-or higher carboxylic acid monomers such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, and 1,2,7,8-octane tetracarboxylic acid.

The proportion of the polyester in the toner is preferably from 20 to 60 percent by mass.

When the polyester content is at least 20 percent by mass, the grindability does not decrease, and the charging performance also do not deteriorate, so that the stability of the toner is not impaired.

When the polyester content is at most 60 percent by mass, flexibility can be maintained, and cracking does not occur in the toner layer formed on a flexible transfer medium.

### Thermoplastic Elastomer

As the thermoplastic elastomer, at least one member selected from the group consisting of styrene-based, polyolefin-based, polyvinyl chloride-based, polyurethane-based, polyamide-based, polyurea-based, polyester-based, and fluororesin-based elastomers may be used. Among these, a polyurethane elastomer is preferred.

The polyurethane elastomer for use in the toner for the thermal transfer print sheet is suitable as a binder resin for the present disclosure, because it generally exhibits excellent tensile strength, abrasion resistance, elasticity, and oil resistance.

Compositionally, using a polyurethane elastomer obtained from substances such as 1,4-butanediol (1,6-hexane diol), adipic acid, and diphenylmethane diisocyanate is preferable. There is no specific limitation on the commercially available polyurethane elastomer. It can be suitably selected according to a particular application. Specific examples include, but are not limited to, hotmelt powder ECOFREEN POWDER, available from ECOFREEN, T8175N andT5102S, available from DIC Covestro Copolymer Ltd., E780OM128, P22MBRNATm and E360MSXW (available from Nippon Miractan Co., Ltd.) and 571F (available from BASF).

The polyurethane elastomer preferably has both a softening point and a glass transition temperature of at most 45 degrees Celsius. When the polyurethane elastomer has a softening point and a glass transition temperature of at most 45 degrees Celsius, the resulting fixed toner layer exhibits sufficient flexibility.

The polyester resin preferably has a softening point and a transition temperature of at least 55 degrees Celsius. When the polyester has a softening point and a glass transition temperature of at least 55 degrees Celsius, the resulting toner image exhibits excellent thermal storage stability.

When polyester and a polyurethane elastomer are used in combination, a sea-island structure can be formed in an incompatible state. The polyurethane elastomer is used in combination with the polyester.

The toner for use in the present disclosure contains a polyurethane elastomer and a polyester.

In the sea-island structure observed in a cross section of the toner, the domains preferably contain the polyurethane elastomer, whereas the matrix contains the polyester resin, and the domains and the matrix are preferably incompatible with each other.

The polyurethane elastomer preferably has a weight average molecular weight of from 20,000 to 100,000, more preferably from 20,000 to 80,000, and furthermore preferably from 20,000 to 60,000. A weight average molecular weight of at least 20,000 prevents a fixed image from running upon ironing it. A weight average molecular weight of at most 100,000 facilitates the melt-kneading of an adhesive with other toner components during toner production.

There is no specific limitation on the content of the polyurethane elastomer, and it can be appropriately selected according to a particular application. It is preferable that the content be 40 to 70 percent based on the mass of the toner, with a more preferable range being 50 to 60 percent by mass. A polyurethane resin content of at least 40 percent by mass based on the toner enables sufficient fixation on flexible media such as cloth and also allows the formation of a flexible fixed toner layer. A content of no more than 70 percent by mass maintains the thermal stability of toner and prevents particle agglomeration thereof.

In addition, all or part of the polyurethane elastomer can be substituted with any polyethylene terephthalate, polyethylene isophthalate, polybutylene terephthalate, polybutylene isophthalate, and styrene-butadiene rubber having the same properties as the polyurethane elastomer.

### Method of Measuring Volume-Based Particle Diameter and Particle Size Distribution of Toner

The volume-based particle size distribution and particle diameter can be measured with, for example, a particle size measuring device (Multisizer III, available from Beckman Coulter, Inc.) at an aperture of 100 μm, followed by analyzing with an analysis software called BeckmanCoulterMultisizer 3 Version 3.51). One example thereof is as follows.

Specifically, 0.5 ml of 10 percent by mass surfactant (alkylbenzene sulfonate, NEOGEN SC-A, available from Daiichi Kogyo Co., Ltd.) is placed in a glass beaker (100 ml). A total of 0.5 g of each toner is loaded into the beaker and stirred by a micro spatula. Next, 80 ml of deionized water is added to the mixture to obtain a liquid dispersion. The thus-obtained liquid dispersion is subjected to dispersion treatment for ten minutes with an ultrasonic wave dispersion device (W-113MK-II, available from Honda Electronics) to obtain a liquid dispersion sample of the toner. The liquid dispersion sample of the toner is measured with the MULTISIZER III mentioned above using ISOTON® III (available from BECKMAN COULTER INC.) as a measuring solution to obtain the particle diameter and particle size distribution. The sample is added dropwise when measuring the volume-average particle diameter of the toner so that the indicated concentration of the device is adjusted to 8+2 percent, thereby ensuring accurate particle diameter measurement.

### Particle Size Distribution and Volume Average Particle Diameter of Toner

The toner for the transfer medium adhesive layer related to the present disclosure has no particular limitation on its particle size distribution on a volume-percent basis and may be selected as appropriate according to a particular application. The volume average particle diameter of the toner is also not particularly limited and may be appropriately selected according to a particular application; however, it is preferably from 10 to 25 μm, and more preferably from 12 to 20 μm.

When a toner having the above properties is used, an increase in the toner particle diameter improves development performance, thereby increasing the amount of toner developed in a single development process. This increase makes it possible to increase the pile height of the toner layer and to more effectively fill surface irregularities of a flexible medium such as cloth. In addition, it is preferable for the toner to have a volume-based particle size distribution with a peak within a range of from 10 to 25 μm in order to optimize the trade-off between the toner particle size and the transferability. For the same reason, a toner with a volume average particle diameter of from 12 to 20 μm is more preferable.

### Method of Measuring Volume Percent-Based Particle Diameter and Particle Size Distribution of Toner

The volume percent-based particle size distribution and particle diameter can be measured with, for example, a particle size measuring device (Multisizer III, available from Beckman Coulter, Inc.) at an aperture of 100 μm, followed by analyzing with an analysis software called BeckmanCoulterMultisizer 3 Version 3.51). One example thereof is as follows.

Specifically, 0.5 ml of 10 percent by mass surfactant (alkylbenzene sulfonate, NEOGEN SC-A, available from Daiichi Kogyo Co., Ltd.) is placed in a glass beaker (100 ml). A total of 0.5 g of each toner is loaded into the beaker and stirred by a micro spatula. Next, 80 ml of deionized water is added to the mixture to obtain a liquid dispersion. The thus-obtained liquid dispersion is subjected to dispersion treatment for ten minutes with an ultrasonic wave dispersion device (W-113MK-II, available from Honda Electronics) to obtain the liquid dispersion sample of the toner. The liquid dispersion sample of the toner is measured with the MULTISIZER III mentioned above using ISOTON® III (available from BECKMAN COULTER INC.) as a measuring solution to obtain the particle diameter and particle size distribution of the toner. The sample is added dropwise when measuring the volume-average particle diameter of the toner so that the indicated concentration of the device is adjusted to 8+2 percent, thereby ensuring accurate particle diameter measurement.

### Confirmation of Presence and Qualification of Resin in Toner

The presence of the resin in the toner of the present disclosure can preferably be confirmed and quantified using Gas Chromatography-Mass Spectrometry (GC-MS) or Nuclear Magnetic Resonance (NMR). Specific procedures, devices, and conditions are as follows.

### Compositional Analysis by GC-MS

### Preparation of Sample

Toner is dispersed in chloroform, followed by agitating for 24 hours to obtain a liquid dispersion. This liquid dispersion is then centrifuged and only the supernatant was collected. The supernatant retrieved is subjected to evaporation to obtain a dry solid, followed by compositional analysis using a GC-MS. One example of measuring conditions using a GC-MS is as follows. A sample mixture is prepared by adding approximately 1 μL of a methylating agent-a 20 percent methanol solution of tetramethylammonium hydroxide (TMAH)-dropwise to about 1 mg of the sample.

### Measurement Condition

Pyrolysis-gas chromatograph mass spectrometry (Py-GCMS): QP2010, available from Shimadzu Corporation
Heating furnace: Py2020D, available from Frontier Laboratories Ltd.
Heating Temperature: 320 degrees Celsius
Column: Ultra ALLOY-5 (L=30 m, I.D=0.25 mm, Film=0.25 μm, available from GL Sciences Inc.
Column temperature: 50 degrees Celsius (hold time: 1 minute), heated at a rate of 10 degrees Celsius/min to 340 degrees Celsius, and held for 7 minutes
Split ratio: 1:100
Column flow rate: 1.0 mL/min
Ionization method: EI method (70 eV)

### Measurement Mode: Scan Mode

Data for retrieval: NIST 20 MASS SPECTRAL LIB.

### Compositional Analysis by NMR

### Preparation of Sample

Toner is dispersed in chloroform, followed by agitating for 24 hours to obtain a liquid dispersion. This liquid dispersion is then centrifuged and only the supernatant was collected. The dry solid retrieved is used as a sample for ¹H NMR and ¹³C NMR, and subjected to compositional analysis by NMR. A specific method of preparing a sample for ¹H NMR and a sample for ¹³C NMR and specific measuring conditions are as follows.

### 1. Method of Preparing Sample for ¹H NMR

One milliliter (1 mL) of toluene-d8 (available from FUJIFILM Wako Pure Chemical Corporation) is added to 100 mg of a sample, and the mixture is heated using a dryer to dissolve the sample, thereby preparing a sample for ¹H NMR.

### 2. Method of Preparing Sample for ¹³C NMR

One mL of deuterated 1,2-dichloro toluene (available from FUJIFILM Wako Pure Corporation) is added to 100 mg of a sample, followed by heating using a dryer to prepare a ¹³C NMR sample.

### Measurement Condition

NMR device: ECX-500, available from JEOL Ltd.
Nucleus observed: ¹H (500 MHz)
Pulse program: single pulse dec.jxp (¹H)
Pulse angle: 45 degrees
Number of scans: 20,000
Relaxation delay: −4 s
Data points: 32 k
Spectral offset: 100 ppm
Spectral width: 250 ppm
Temperature: 70 degrees Celsius
Nucleus observed: ¹³C (125 MHz)
Pulse program: single pulse dec.jxp (¹³C)
Pulse angle: 45 degrees
Number of scans: 64
Relaxation delay: 5 s
Data points: 32 k
Spectral width: 15 ppm
Temperature: 65 degrees Celsius

### Measurement of Weight Average Molecular Weight

The weight average molecular weight of resin for use in the toner can be obtained by measuring the molecular weight distribution for the resin dissolved in tetrahydrofuran (THF) with a GPC measuring device. There is no specific limitation on the GPC measuring device, and it can be suitably selected according to a particular application. An example is GPC-150C, available from Waters Corporation.

The column for use in measuring the weight-average molecular weight is not particularly limited and can be suitably selected according to a particular application. Specific examples include, but are not limited to, KF801 (column for organic solvent-based SEC (GPC)), KF802 (column for organic solvent-based SEC (GPC)), KF803 (column for organic solvent-based SEC (GPC)), KF804 (column for organic solvent-based SEC (GPC)), KF805 (column for organic solvent-based SEC (GPC)), KF806 (column for organic solvent-based SEC (GPC)), and KF807 (column for organic solvent-based SEC (GPC)) (all available from Showa Denko K.K.).

The method of measuring the weight average molecular weight of resins for use in the toner is not particularly limited and can be suitably selected according to a particular application. One way of measuring is as follows.

The column was stabilized in a heat chamber at 40 degrees Celsius, and tetrahydrofuran (THF) was passed therethrough as a solvent at a flow rate of 1 mL per minute. Next, 0.05 g of a sample was sufficiently dissolved in 5 g of THF, and the resulting solution was filtered through a filter for sample preparation (for example, Chromatodisc, pore size: 0.45 μm, manufactured by Kurashiki Textile Manufacturing Co., Ltd.). The sample concentration was then adjusted to from 0.05 to 0.6 percent by mass. An aliquot of 50 μL to 200 μL of the THF sample solution having the adjusted sample concentration was injected into the column. After separating the THF-soluble components contained in the THF sample solution, the weight-average molecular weight (Mw) of the THF-soluble components was determined by converting the detected signal into molecular weight using a detector (for example, a differential refractive index (RI) detector (instrument name: GPC-150C, manufactured by Waters Corporation)).

The weight average molecular weight Mw and the number average molecular weight Mn of the THF dissolved portion in the sample are calculated from the relationship between the count values and the logarithm values of the calibration curves made from several types of monodispersed polystyrene standard samples.

A the standard polystyrene sample for the calibration curve, it is suitable to use at least about ten standard polystyrene samples individually having a molecular weight of 6×10², 2.1×10², 4×10², 1.75×10⁴, 5.1×10⁴, 1.1×10⁵, 3.9×10⁵, 8.6×10⁵, 2×10⁶, or 4.48×10⁶, available from TOSOH CORPORATION or Pressure Chemical Co., for example.

A refractive index (RI) detector is preferable as a detector.

### Method of Measuring Softening Point

The softening temperature can be measured using a flow tester (CFT-500D, manufactured by Shimadzu Corporation). Specifically, 1.0 g of a sample is extruded through a nozzle having a diameter of 1.0 mm and a length of 1.0 mm while being heated at a heating rate of 6 degrees Celsius/min by the flow tester, under an applied load of 1.96 MPa with a plunger. The plunger displacement of the flow tester with respect to temperature is plotted to obtain an S-shaped curve representing temperature (degrees Celsius)/stroke (mm). The temperature at which deformation of the sample first occurs, i.e., the temperature at which the sample begins to deform as it transitions from a solid state to a rubber-like state, can be determined as the softening temperature.

### Method of Measuring Softening Point

The softening temperature can be measured using a flow tester (CFT-500D, manufactured by Shimadzu Corporation). Specifically, 1.0 g of a sample is extruded through a nozzle having a diameter of 1.0 mm and a length of 1.0 mm while being heated at a heating rate of 6 degrees Celsius/min by the flow tester, under an applied load of 1.96 MPa with a plunger. The plunger displacement of the flow tester with respect to temperature is plotted to obtain an S-shaped curve representing temperature (degrees Celsius)/stroke (mm). The softening point Tm is read from the resulting S-shaped curve. Specifically, the maximum stroke value in the S-shaped curve is defined as S₁, and the stroke value of the baseline on the low-temperature side is defined as S₂. The temperature at which the stroke value in the S-shaped curve becomes (S₁+S₂)/2 is taken as the softening point Tm of the sample.

### Measurement Method of Glass Transition Temperature

The glass transition temperature (Tg) is measurable, for example, using a differential scanning calorimeter (DSC210, manufactured by Seiko Instruments Inc.). Specifically, 0.01 to 0.02 g of a sample is weighed into an aluminum pan at room temperature, and the sample is cooled to −20 degrees Celsius at a cooling rate of 10 degrees Celsius/min using the differential scanning calorimeter. Thereafter, the sample is heated to 200 degrees Celsius at a heating rate of 10 degrees Celsius/min, and the glass transition temperature Tg is determined as the temperature at the intersection between the extrapolated baseline and the tangent line having the maximum slope drawn from the onset portion of the peak toward the peak apex.

### Release Agent

Any release agent (wax) can be used and selected according to a particular application in the toner of the present disclosure. The release agent can be used alone or in combination.

The release agent for use in the present disclosure is not particularly limited and can be suitably selected according to a particular application.

Specific examples include, but are not limited to, aliphatic hydrocarbons such as liquid paraffin, microcrystalline wax, natural paraffin, synthetic paraffin, polyolefin wax, and partial oxides, fluorides, and chlorides thereof; animal oil such as beef tallow and fish oil; vegetable oils such as coconut oil, soybean oil, rapeseed oil, rice bran wax, and carnauba wax; higher aliphatic alcohol or aliphatic acid such as montan wax; aliphatic acid amide, aliphatic acid bisamide; metal soap such as zinc stearate, calcium stearate, magnesium stearate, aluminum stearate, zinc oleate, zinc palmitate, magnesium palmitate, zinc myristate, zinc laurate, and zinc behenate; aliphatic acid esters, and polyvinylydene fluoride. Among these, a release agent containing at least ester wax such as fatty acid esters is preferable.

Ester wax as a release agent can inhibit waste paper jamming caused by failing to separate the toner from a fixing roller or belt during fixing when the toner contains an extreme amount of maleic acid modified polyolefin with a polypropylene block in its main chain. Moreover, ester wax can be finely dispersed in the toner by the maleic acid modified polyolefin with a polypropylene block in its main chain.

The content of the release agent in the toner is not particularly limited and can be suitably selected according to a particular application. It is preferably from 0.1 to 8.0 percent by mass and more preferably from 1.0 to 6.0 percent by mass. A content of at least 0.1 percent by mass separates the toner from a fixing roller or belt during fixing, reducing the occurrences of waste paper jamming.

If the content is at most 8.0 percent by mass, the toner can sufficiently fix on plastic film.

### Charge Control Agent

The toner for use in the present disclosure may optionally contain a charge control agent.

The charge control agent may be appropriately selected according to a particular application, as long as it is white or colorless. Specific examples include, but are not limited to, onium salts such as phosphonium salts and lake pigments thereof; triphenylmethane dyes and lake pigments thereof; metal salts of higher aliphatic acids; diorganotin oxides such as dibutyltin oxide, dioctyltin oxide and dicyclohexyltin oxide; diorganotin borates such as dibutyltin borate, dioctyltin borate, dicyclohexyltin borate; organometallic complexes, chelate compounds, monoazo metal complexes, acetylacetone metal complexes, metal complexes of aromatic hydroxycarboxylic acids and aromatic dicarboxylic acid; and quaternary ammonium salts. Other examples include, but are not limited to, aromatic hydroxycarboxylic acid, aromatic mono- and polycarboxylic acid and their metal salts, anhydrides, esters, and phenol derivatives such as bisphenol. These can be used alone or in combination.

The amount of the charge control agent internally added to the electrophotographic toner is not particularly limited and may be suitably selected according to an intended application. Preferably, the amount is in the range of 0.1 to 10 percent by mass based on the total mass of the binder resin.

### External Additive

The toner of the present disclosure can use substances such as inorganic fine particles (inorganic particulates) as external additives.

The inorganic particulates externally added to the toner of the present disclosure are not particularly limited and can be suitably selected according to a particular application. Specific examples include, but are not limited to, silica, alumina, titanium oxide, barium titanate, magnesium titanate, calcium titanate, strontium titanate, zinc oxide, silica sand, clay, mica, wollastonite, diatomaceous earth, chromium oxide, cerium oxide, iron oxide, antimony trioxide, magnesium oxide, zirconium oxide, barium sulfate, barium carbonate, calcium carbonate, silicon carbide, and silicon nitride. Of these, silica, alumina, and titanium oxide are preferable.

This inorganic fine particle may be surface-treated with a hydrophobizing agent. The hydrophobizing agent is not particularly limited and can be suitably selected according to a particular application. Examples include, but are not limited to, silane coupling agents, silylating agents, silane coupling agents with a fluorinated alkyl group, organic titanate-based coupling agents, and aluminum-based coupling agents. Moreover, the use of silicone oil as a hydrophobizing agent yields sufficient performance.

The average diameter of the primary particle of the inorganic fine particles is not particularly limited and can be suitably selected according to a particular application. It is preferably 5 to 500 nm and more preferably from 5 to 200 nm.

An average diameter of at least 5 nm inhibits the agglomeration of inorganic fine particles, uniformly dispersing the inorganic fine particles in the toner. An average diameter of at most 500 nm can enhance the thermal storage stability through the filler effect. The average particle diameter is determined by directly measuring the particle size from a transmission electron microscope (TEM) image. It is preferable to measure at least 100 particles and use the average of their major diameters.

### Flowability Enhancer

The present disclosure may contain a flowability enhancer as an additive. There is no particular limitation on the flowability enhancer mentioned above and it can be suitably selected according to a particular application as long as it is surface-treated for enhancing hydrophobicity and can keep the fluidity and chargeability even in a highly humid environment. Specific examples include, but are not limited to, silane coupling agents, silylating agents, silane coupling agents including an alkyl fluoride group, organic titanate coupling agents, aluminum-containing coupling agents, silicone oil, and modified silicone oil.

If used as external additives, silica and titanium oxide are preferably employed in hydrophobized form, obtained by surface treatment with a flowability enhancer such as those exemplified above.

### Cleaning Improver

The present disclosure may contain a cleaning improver as an additive. The cleaning improver is not particularly limited and can be suitably selected according to a particular application as long as the cleaning improver added to the toner according to an embodiment of the present disclosure can remove the developing composition remaining on the photoconductor or a primary transfer medium after image transfer. Specific examples include, but are not limited to, zinc stearate, calcium stearate, and aliphatic metal salts of stearic acid, fine polymer particles such as polymethyl methacrylate fine particles and polystyrene fine particles, which are prepared by a soap-free emulsion polymerization method. The polymer fine particles preferably have a relatively sharp particle size distribution and its volume average particle diameter is preferably from 0.01 to 1 μm.

### Developing Composition

The toner used in the image forming method relating to the present disclosure may also be mixed with a carrier and used as a developing composition. The developing composition contains the toner relating to the present disclosure and other optional components such as a carrier. Using this developing composition, an underlying layer with excellent fixability can be formed on the surface of the fabric.

The developing composition may be either a one-component type or a two-component type.

In view of a longer service life, the two-component developing composition is preferable for high-speed printers designed to accommodate recent advances in information processing.

When the toner is used as a one-component developing composition, the toner exhibits little variation in particle size even after toner replenishment.

Owing to this stability, the toner is less likely to form a film on the developing roller or to fuse onto members such as a blade for forming a thin toner layer.

Accordingly, even under prolonged agitation in the developing device, good and stable developability as well as high-quality images can be obtained.

The toner can be mixed with a carrier to form a two-component developing composition. This agent can be used for electrophotography using a two-component developing composition. When the toner is used as a two-component developing composition, the toner exhibits little variation in particle size even after prolonged toner replenishment, and good, stable developability and image quality can be obtained even during long-term agitation in the developing device.

### Magnetic Material

The magnetic fine particle (particulate) for use in magnetic carrier used in a two-component developing composition is not particularly limited and can be suitably selected according to a particular application.

Examples of the magnetic particulates include, but are not limited to, spinel ferrites such as powdered iron, magnetite, and gamma ferric oxide, spinel ferrites containing one or two types of non-iron metals such as Mn, Ni, Zn, Mg, and Cu, magnetoplumbite type ferrites such as barium ferrite, and iron or alloyed metal particles with an oxidized layer on the surface. Of these, white materials are preferable in terms of color tone.

The magnetic particulate includes a granular, spherical, or acicular magnetic particulate.

Using ferromagnetic particulates such as iron is preferable to obtain a strongly magnetized carrier.

In addition, in terms of chemical stability, it is preferable to use spinel ferrite such as magnetite and gamma ferric oxide and magnetoplumbite type ferrite such as barium ferrite. Specific examples include, but are not limited to, MFL-C 35S, MFL-C 35HS (available from Powdertech CO., Ltd.), DFC-C 400M, DFC-C 410M, and SM-C 350NV (available from Dowa IP Creation Co., Ltd.).

A resin carrier with a desired magnetization can be used depending on the type and content of a ferromagnetic particle (carrier).

Preferably, such a resin carrier has a magnetization of from 30 to 150 emu/g in 1,000 oersted.

Such resin carriers can be manufactured by spraying, using a spray dryer, a melt-kneaded mixture of magnetic fine particles and an insulating binder resin. It is also possible to produce resin carriers in which magnetic fine particles (carrier) are dispersed in a condensation-type binder formed by reacting and curing monomers or prepolymers in an aqueous medium in the presence of magnetic fine particles.

The magnetized carrier can be coated with resin or have positively or negatively charged particulates or electroconductive particulates fixated on the surface of the magnetized carrier to control the chargeability.

The coating material (resin) for the surface of the magnetized carrier includes, but is not limited to, silicone resins, acrylic resins, epoxy resins, and fluorochemical resins. Furthermore, the coating may contain positively or negatively charged or electroconductive particulates. Of these, silicone resins and acrylic resins are preferable.

In the present disclosure, the mass ratio of the carrier to the developing composition accommodated in a developing device is preferably 85 to less than 98 percent by mass.

A mass ratio of the carrier to a developing composition of at least 85 parts by mass reduces toner scattering from a developing device and decreases the production of defective images.

A mass ratio of the carrier to the developing composition of less than 98 percent by mass inhibits an extreme increase in the charge size of the electrophotographic developing toner and minimizes toner supply shortages, thereby reducing the occurrence of defective images due to decreased image density.

The weight average molecular weight of the magnetic carrier is preferably from 50 to 80 μm. In the image forming method relating to the present disclosure, it is preferable to use a toner that is developable and has the largest particle diameter possible, and to perform development in a single pass. When the volume average particle diameter of the magnetic carrier is less than 50 μm, carrier adhesion tends to occur, whereby the magnetic carrier is developed together with the toner. When the particle diameter is at most 80 μm, the decrease in the amount of development, toner scattering, and background fouling can be more readily suppressed.

### Transfer Sheet

The transfer sheet for use in the image forming method relating to the present disclosure is not particularly limited as long as it has releasability (peelability) and is a sheet-like substrate on which an image layer and an adhesive layer printed thereon can be transferred to a transfer medium by heat and pressure. In a preferred transfer sheet, a transfer layer containing at least a thermoplastic elastomer and a higher fatty acid is formed on a substrate made of paper or a heat-resistant plastic film sheet.

The formation of a release layer made of a thermoplastic elastomer as the uppermost image layer improves the durability of the image on the transfer medium. Further, by containing a higher fatty acid, the higher fatty acid melts during thermal transfer and diffuses into the color toner layer and the transfer medium adhesive toner layer formed simultaneously, thereby further improving the flexibility of the layers.

The color image formed on the transfer sheet is a mirror image in which the original image is reversed left-to-right. After being thermally transferred to the transfer medium, the image is reversed left-to-right again to obtain the desired final image. Similarly, since the transferable-material adhesive layer image formed on the color-image-formed transfer sheet is formed on top of the color image on the transfer sheet, it also becomes a left-right reversed mirror image with respect to the original image.

The formation of the left-right reversed mirror image is carried out by printing image data that has been previously reversed left-to-right using an instrument such as a PC. In the case of an image forming apparatus equipped with a scanner function, the original may be scanned and then subjected to a reversing process prior to output, or a previously reversed mirror image may be scanned directly.

### Transferable Medium

The method of forming a thermal transfer print sheet image is capable of printing on a wide variety of materials and shapes of transfer medium that cannot be directly printed on.

Any material that does not undergo excessive deformation during heat-and-pressure transfer can be printed on, including various materials such as paper, plastic, cloth, leather, ceramics, glass, metal, and painted surfaces such as paint coatings.

In particular, the field in which the image-forming effect of the thermal transfer print sheet produced by the image forming method relating to the present disclosure can be exhibited is the garment printing field.

As garments, materials having flexibility and stretchability, such as cotton, polyester, polyurethane, nylon, rayon, silk, wool, and composite fibers thereof, allow formation of high-quality, highly saturated images while maintaining crack resistance and washability. Furthermore, even for highly flexible transfer medium such as leather, the image can follow deformation, thereby enabling the formation of highly durable images.

Moreover, the toner for thermal transfer print sheets used in the present disclosure is capable of forming high-strength images and provides sufficient image durability even on metal, ceramics, glass, painted surfaces, and other coated surfaces. By using the toner for thermal transfer print sheets of the present disclosure, it becomes possible to easily obtain custom design and labeling of articles such as mugs, cups, dishes, accessories, various tools, automotive parts, machine tool parts, furniture, and signboards.

### Method of Manufacturing Toner

The method of manufacturing the toner for a transfer sheet (printing medium) related to the present disclosure is not particularly limited and can be suitably selected to suit to a particular application. One way of manufacturing the toner of the present disclosure is described below.

As a method of producing the toner for thermal transfer print sheets of the present disclosure, the melt-kneading and pulverization method is preferred. This is because the white pigment has a higher specific gravity than the other toner components, making granulation by chemical methods such as dissolution-suspension polymerization difficult, and because, in order to form filamentous domains, it is necessary to include a step in which a melt-kneaded mixture of the toner components is cooled and roll-milled.

In contrast, chemical methods such as dissolution-suspension polymerization may be used in the present disclosure, provided that the internal dispersion of the white pigment is achievable and that toner material compositions and processes capable of forming filamentous domains are adopted.

The size and the shape of filamentous domains are related to the compatibility between the domain materials and matrix materials (depending on the molecular weight and compositions of individual materials) and the force of extension applied to a melt-kneaded substance during cold rolling. The easiest method of controlling the domain size and shape is to employ materials non-compatible with each other and adjust the melt-kneaded substance of the toner material to have an appropriate thickness (preferably 1 or less mm) based on the relationship between the domain's size and shape and the rolled thickness obtained in advance. The resulting domain is large and filamentous.

One embodiment of the method of manufacturing the toner relating to the present disclosure includes obtaining a binder resin mixture (mixing process), obtaining a kneaded substance of the mixture (melt-kneading process), obtaining a solid of kneaded substance (solidifying process), and obtaining a pulverized substance of the solid (finely pulverizing process), and classifying and collecting the pulverized substance (classifying process).

### Obtaining Mixture of Binder Resin (Mixing Process)

A binder resin, a colorant, a release agent, and optional substances such as a charge control agent are mixed with a mixer to obtain a mixture (mixing process).

The mixer is not particularly limited and can be suitably selected according to a particular application. Examples include, but are not limited to, a Henschel Mixer (FM20B, available from NIPPON COKE & ENGINEERING. CO., LTD.) and a super mixer (SMV-20Ba, available from KAWATAMFG Co., Ltd.).

### Obtaining Melt-Kneaded Product of Mixture

Then the mixture obtained is melt-kneaded using a hot melt-kneading machine to obtain a kneaded substance (melt-kneading process).

The melt-kneading device is not particularly limited and can be suitably selected according to a particular application. Specific procurable products include, but are not limited to, a two-screw extruder (PCM series, available from IKEGAI CORPORATION), a TEM extruder (available from SHIBAURA MACHINE CO., LTD.), a two-screw extruder PCM kokneader, available from Buss AG, and an open roll continuous kneader (KNEADEX, available from NIPPON COKE & ENGINEERING. CO., LTD.).

### Obtaining Solidified Product of Melt-Kneaded Product

Then the kneaded substance obtained is cooled and solidified to yield a solid product (solidifying process). There is no specific limitation on the cooling and solidifying and it can be suitably selected according to a particular application. Any method known in the art can be used.

However, in order to efficiently perform micronization in the subsequent fine-pulverization step, it is desirable that the solidification step produce coarse particles that are reduced to a certain particle size.

One preferred way for this step is to pelletize a kneaded material in the solidification step following the kneading step.

Examples of pelletizing processes include the strand-cut method, the water-cooled hot-cut method, and the underwater-cut method.

For example, in the strand-cut method, a kneaded melt immediately after the kneading step is extruded through a die having a diameter of about 3 mm to form strands, which are then cooled by a cooling device such as a water bath, and after cooling, cut with a pelletizer to form pellets.

The particle size of the pellets can be appropriately adjusted by controlling the feed rate of the melt-kneading step and the feed rate of the pelletizer to regulate the strand thickness, and by adjusting the cutting width.

The preferred pellet particle size is from 0.5 mm to 3 mm in diameter, more preferably from 1 mm to 2 mm in diameter. In the coarse-particle formation prior to the fine-pulverization step, as the particle size decreases, the micronization becomes more efficiently.

However, as the strand diameter is reduced, the strands tend to break during processing, resulting in reduced process stability. Therefore, pelletizing at a diameter of at least 1 mm is preferred.

### Obtaining Pulverized Product of Solid (Fine Pulverization Process)

Subsequently, the obtained solid product is finely pulverized to yield a pulverized material (fine pulverization process). The solid product may be pulverized using known pulverization methods: For example, a jet mill method in which toner is entrained in a high-speed airflow and pulverized by the energy of impact against a collision plate; a particle collision method in which toner particles collide with each other in an airflow; or a mechanical pulverization method in which toner is fed into a narrow gap with a rapidly rotating rotor and pulverized.

It is preferable to use a low-temperature pulverization method to pulverize the toner for transfer sheets related to the present disclosure.

Substances have a property of becoming abruptly brittle below a certain temperature, which is referred to as “low-temperature brittleness.” This property facilitates pulverizing materials such as rubber and plastics, which are difficult to pulverize at room temperature. Low-temperature pulverization using the extremely low temperature of liquid nitrogen (−196 degrees Celsius) is also referred to as “cryogenic pulverization” or “freeze pulverization.”

The freeze-pulverization method greatly improves pulverizability, and the shape of the pulverized particles also becomes more stable, thereby enabling the production of fine pulverized particles suitable for use as toner. In this freeze pulverization, it is preferable to employ a mechanical pulverization method in which the toner is supplied into a narrow gap with a rapidly rotating rotor and pulverized.

Specifically, a coarse-particle kneaded material is charged into a cooling chamber, cooled with liquid nitrogen, and then processed in a pulverizer, followed by classification through sieving to obtain particles having a target particle size or smaller. Coarse particles remaining on the sieve are returned to the cooling chamber for repulverization.

### Classifying and Collecting Pulverized Material (Classifying Process)

Next, the pulverized material is classified, and the classified material with a particular volume average particle diameter are collected. A toner is thus obtained (classifying process). The classification method is not particularly limited and may be appropriately selected according to a particular application, such as an air-flow type or a rotating-rotor type.

Examples of air-flow classifiers include an Elbow Jet classifier (manufactured by Matsubo Co., Ltd.), and examples of rotating-rotor classifiers include a TSP separator and a TTSP separator (manufactured by Hosokawa Micron Corporation).

The toner relating to the present disclosure can be manufactured by a dissolution suspension method. In the dissolution suspension method, an oil phase, in which toner materials containing a binder resin, a colorant, a release agent, and other optional materials such as a charge control agent are dissolved or dispersed, is dispersed in an aqueous medium (aqueous phase) to allow the binder resin to react. This reaction affords a liquid dispersion containing a dispersion (oil droplets) containing a prepolymer of emulsified or dispersed toner materials. Thereafter, the organic solvent is removed from the liquid dispersion, followed by filtering, rinsing, drying, and optional processes such as classifying. Mother toner particles are thus obtained. The toner according to an embodiment of the present invention is obtained by granulating the mother particles obtained by a suspension of solution and solvent removal method.

The organic solvent is not particularly limited and can be suitably selected according to a particular application. An organic solvent with a boiling point of at most 150 degrees Celsius is preferable for easy removal.

Such organic solvents with a boiling point of at most 150 degrees Celsius are not particularly limited and they can be suitably selected according to a particular application.

Specific examples include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These can be used alone or in combination.

Of these, ethyl acetate, toluene, xylene, benzene, methylene chloride, 1,2-dichloroethane, chloroform, and carbon tetrachloride are preferable and ethyl acetate is particularly preferable.

The aqueous medium is not particularly limited and can be suitably selected according to a particular application. It includes, for example, water, a solvent miscible with water, and a mixture thereof. These can be used alone or in combination. Of these, water is preferable.

The solvent miscible with water is not particularly limited and can be suitably selected according to a particular application. It includes, for example, alcohol, dimethyl formamide, tetrahydrofuran, cellosolves, and lower ketones.

Alcohol is not particularly limited and can be suitably selected according to a particular application. It includes, for example, methanol, isopropanol, and ethylene glycol.

Lower ketones are not particularly limited and can be suitably selected according to a particular application. It includes, for example, acetone and methylethyl ketone.

The method of removing the organic solvent from a liquid dispersion is not particularly limited and can be suitably selected according to a particular application. It includes, for example, a method of evaporating the organic solvent in oil droplets by gradually heating the entire reaction system and a method of spraying a liquid dispersion in dried atmosphere to remove the organic solvent in oil droplets.

Classification in the suspension of solution and solvent removal method can be carried out by removing fine particles in liquid with a cyclone, decanter, or centrifuge or performed after drying a liquid dispersion.

Through the above steps, the toner base material for the thermal transfer print sheet of the present disclosure can be produced.

### Mixing External Additives and Sieving Agglomerates (Mixing/Sieving Step)

To the obtained toner base material, external additives such as silica and titanium oxide fine particles are mixed in order to adjust powder characteristics and chargeability required for use as toner, and agglomerates generated during mixing are sieved out and removed.

As the external additive mixer, a stirring mixer is preferably used. Examples include a Henschel mixer (manufactured by Mitsui Mining Co., Ltd.), a Super Mixer (manufactured by Kawata Co., Ltd.), and a TSK mixer (manufactured by Tsukishima Kikai Co., Ltd.).

### Image Output Apparatus (Image Forming Apparatus)

The electrophotographic output apparatus for use in the present disclosure is an electrophotographic printer equipped with multiple developing stations. In each station, at least a clear toner; or a toner containing a white pigment, a polyester, a polyurethane elastomer, and a wax; or a toner containing a black pigment, a polyester, a polyurethane elastomer, and a wax is installed.

In each developing station, it is preferable to form a toner layer having a thickness of at least 15 μm in a single pass. If the amount of deposited toner is insufficient, image formation may be performed by using the same toner in multiple developing stations or by increasing the number of printing passes. First, a clear layer having an arbitrary thickness is formed, then an image layer is formed with color ink or color toner, and subsequently a white or black achromatic toner layer having an arbitrary thickness is formed by adjusting with multiple devices or multiple passes.

The advantages thereof include expanding the options of the colored image layer and improving applicability.

The thickness of the adhesive layer is greater than that of the clear layer, and the layer ratio defined by “thickness of adhesive layer/thickness of clear layer” exceeds 1.0. A ratio of at least 1.1 is preferred, and a ratio of 1.5 to 4.0 is more preferred.

The thickness of the clear layer is at least 5 μm. Preferably, the thickness is at least 10 μm, and more preferably 20 to 50 μm.

The thickness of the image layer is preferably at least 1 μm, and more preferably 2 to 5 μm.

The thickness of the adhesive layer is preferably at least 20 μm, and more preferably 40 to 110 μm.

The amount of toner required for image formation varies depending on the material and lightness of the transfer medium (target). In the case of a smooth transfer medium, a toner layer having a thickness of at least 15 μm allows vivid color images to be obtained even when forming images on dark (low-lightness) transfer media, while suppressing a decrease in saturation of the color image. When the toner layer has a thickness of at least 30 μm, an even clearer color image can be obtained.

If the thickness exceeds 100 μm, it becomes difficult to set fixing conditions capable of reducing hot offset and cold offset, and stable image quality becomes difficult to achieve.

Among the multiple developing stations, all stations may use toners of different colors, or two or more stations may use toners of the same color, and the combination may be selected according to a particular application.

When multicolor printing is intended, using toners of different colors in each station reduces the frequency of color replacement and improves efficiency.

For printing with at most two colors, the same color toner may be used in multiple developing stations, such as using a first color toner in the first and second stations and a second color toner in the third and fourth stations, so that the required amount of each color toner can be laid down with fewer printing passes.

Furthermore, by using an image output apparatus in which all the developing stations use a toner of a single color, the required amount of each color toner can be deposited in a single printing pass. Color replacement of the toners becomes unnecessary, further improving efficiency.

However, as this configuration increases equipment cost and installation space, the configuration is preferably selected according to a particular application.

The image output apparatus in the present disclosure includes at least two electrostatic latent image bearers, electrostatic latent image forming devices, and developing devices, and other optional devices.

The image forming method relating to the present disclosure includes forming an electrostatic latent image, developing the electrostatic latent image, and other optional processes.

The image forming method can be suitably conducted by the image forming apparatus. The electrostatic latent image can be suitably formed with the electrostatic latent image forming device. The electrostatic latent image can be suitably developed with the developing device. The other optional processes can be suitably conducted by the corresponding other optional devices.

### Electrostatic Latent Image Bearer

There is no specific limitation on the material, the structure, and the size of the electrostatic latent image bearer. The image bearer can be suitably selected from any known image bearer. For example, an inorganic photoconductor formed of amorphous silicon or selenium or an organic photoconductor formed of polysilane, azo pigment, and titanyl phthalocyanine are listed.

The electrostatic latent image bearer is not particularly limited and can be suitably selected according to a particular application. An electrostatic latent image bearer having a cylindrical form is preferable. The outer diameter of a cylindrical photoconductor is not particularly limited and can be suitably selected according to a particular application. It is preferably from 3 to 100 mm, more preferably from 3 to 100 mm, and furthermore preferably from 20 to 50 mm.

Electrostatic latent Image Forming Device and Electrostatic latent Process

The electrostatic latent image forming device has no particular limitation as long as it can form an electrostatic latent image on an electrostatic latent image bearer and can be suitably selected according to a particular application. For example, a device including a charging member for charging the surface of an electrostatic latent image bearer and an irradiating device for irradiating the surface of the electrostatic latent image bearer imagewise is suitable.

The electrostatic latent image forming process has no particular limitation as long as it can form an electrostatic latent image on the electrostatic latent image bearer and can be suitably selected according to a particular application. For example, the process is conducted by charging the surface of an electrostatic latent image bearer and irradiating the surface imagewise with the electrostatic latent image forming device.

### Charger and Charging

The charging device (charger) is not particularly limited and can be suitably selected according to a particular application.

Specific examples include, but are not limited to, a known contact type charger that includes an electroconductive or semiconductive roller, brush, film, or a rubber blade, and a non-contact type charger using corona discharging such as corotron and scorotron.

Charging is accomplished, for instance, by applying a bias to the surface of the image bearer using the charging device.

The charging device may employ a roller form and any other form such as a magnetic brush and a fur brush, and can be selected according to the specification or form of an image forming apparatus.

The charging device is not limited to the contact type charging device but is preferably used because such a charging member contributes to manufacturing an image forming apparatus producing less amount of ozone.

### Irradiating Device and Irradiation

The irradiating device (irradiator) is not particularly limited and can be suitably selected according to a particular application as long as it can irradiate the surface of an electrostatic latent image bearer charged with the charger imagewise.

Specific examples include, but are not limited to, a photocopying optical system, a rod lens array system, a laser optical system, and a liquid crystal shutter optical system.

The light source for the irradiator has no particular limitation and can be suitably selected according to a particular application.

Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used to irradiate an electrostatic latent image bearer with beams of light having only a desired wavelength.

It includes, but is not limited to, a sharp cut filter, a band-pass filter, a near infrared filter, a dichroic filter, a coherent filter, and a color conversion filter.

The irradiation is conducted by, for example, irradiating the surface of the electrostatic latent image bearer with the irradiator.

In the present disclosure, a dorsal irradiation system can be employed, where the electrostatic latent image bearer is irradiated from the rear side in an imagewise manner.

### Developing Device and Developing Process

The developing device is not particularly limited and can be suitably selected according to a particular application as long as it can contain a toner for developing an electrostatic latent image formed on an electrostatic latent image bearer to form a toner image as a visible image.

The developing process is not particularly limited and can be suitably selected according to a particular application, provided that it develops an electrostatic latent image on an electrostatic image bearer with a transfer-medium-adhesive toner to form a visible toner image. For example, the developing process can be conducted by the developing device.

Preferably, the developing device includes a stirrer for triboelectrically charging toner, a magnetic field generator fixed inside the developing device, and a rotatable developing composition bearer, the bearer bearing a developing composition containing the toner on its surface.

In the developing device, for example, the toner and the carrier are mixed and stirred to triboelectrically charge the toner due to the friction therebetween. The toner is held on the surface of the rotating magnet roller, forming a magnet brush like a filament. The magnetic roller is disposed in the vicinity of the electrostatic latent image bearer. Some of the toner forming the magnet brush on the surface of the magnet roller is electrically attracted to the surface of the electrostatic latent image bearer. As a result, the electrostatic latent image is developed with the toner and rendered visible as a toner image on the surface of the electrostatic latent image bearer.

### Other Optional Device and Other Optional Process

Examples of the aforementioned other devices include, but are not limited to, a transfer device, a fixing device, a cleaning device, a discharging (quenching) device, a recycling device, and a controlling device.

The other processes include, for example, a transfer process, a fixing process, a cleaning process, a discharging process, a recycling process, and a controlling process.

### Transfer Device and Transfer Process

The transfer device has no particular limitation as long as it can transfer the transfer medium adhesive image to a color image medium and can be suitably selected according to a particular application. For example, the transfer device preferably includes a primary transfer device for transferring transfer medium adhesive images onto an intermediate transfer member to form a complex transfer image and a secondary transfer device for transferring the complex transfer image to a color image medium.

The transfer process has no particular limitation as long as it can transfer a transfer medium adhesive image onto a color image medium and can be suitably selected according to a particular application.

It is preferable to employ a configuration in which a transfer medium adhesive image is primarily transferred to an intermediate transfer member and thereafter secondarily transferred to color image.

The transfer process can be performed by, for example, charging the electrostatic latent image bearer (photoconductor) with a transfer charging device to transfer the transfer medium adhesive image. The transfer process can be carried out by the transfer device.

When the image to be secondarily transferred onto the color image medium is a transfer medium adhesive image formed of two types of transfer medium adhesive toners, namely a clear toner and a white toner, the configuration may be such that the transfer medium adhesive toners are successively superposed on the intermediate transfer member by the transfer device to form an image thereon, and the intermediate transfer device then collectively performs secondary transfer of the image on the intermediate transfer member onto the color image medium.

The intermediate transfer member is not particularly limited and can be suitably selected from known transfer members, including a transfer belt.

The transfer device (the primary transfer device, the secondary transfer device) preferably has a transfer unit for peeling-charging the visible image formed on the image bearer to the side of the recording medium. Specific examples of the transfer unit include, but are not limited to, a corona transfer unit using corona discharging, a transfer belt, a transfer belt, a transfer roller, a pressure transfer roller and an adhesive transfer unit.

The color image medium is a transfer sheet on which a color image is printed.

The transfer sheet is not particularly limited as long as it can receive a developed, unfixed image, and may be appropriately selected according to a particular application. Transfer paper having a transfer layer, release paper having a release layer, and release films may also be used.

### Fixing Device and Fixing

The fixing device has no particular limitation provided that it can fix a transfer image transferred onto a color image medium and can be suitably selected according to a particular application. Known heating and pressing devices are preferable. As the heat and pressure member, for example, a combination of a heating roller and a pressure roller and a combination of a heating roller, a pressure roller, and an endless belt can be used.

The fixing process is not particularly limited as long as it can fix the transfer medium adhesive image that has been transferred onto the color image medium, and may be appropriately selected according to a particular application. This fixing is performed simultaneously in one operation while the developed images of the respective colors are being stacked.

The fixing process can be conducted by the fixing device.

Such a heating and pressing member preferably conducts heating at a heating temperature of from 80 to 200 degrees Celsius.

In the present disclosure, for example, any known optical fixing device can be used in combination with or in place of the fixing device depending on a particular application.

There is no specific limitation on the surface pressure in the fixing process and it can be suitably selected according to a particular application. Preferably, the surface pressure is from 10 to 80 N/cm².

### Cleaner and Cleaning Process

There is no specific limitation on the selection of the cleaning device (cleaner) and any known cleaner that can remove the toner remaining on the image bearer is suitably used.

Specific examples of such cleaners include, but are not limited to, a magnetic brush cleaner, an electrostatic brush cleaner, a magnetic roller cleaner, a blade cleaner, a brush cleaner, and a web cleaner.

Any cleaning process that can remove the toner remaining on the image bearer is suitably used. For example, the cleaning process can be conducted by the cleaning device mentioned above.

### Discharging Device and Discharging Process

The quenching (discharging) device has no particular limitation as long as it can apply a discharging bias to a photoconductor for discharging and can be suitably selected according to a particular application. For example, a discharging lamp is suitable.

The discharging process has no specific limitation as long as it includes applying a discharging bias to a photoconductor for discharging and can be suitably selected according to a particular application. For example, the charging process can be conducted by the charging device.

### Recycling Device and Recycling Process

The recycling device has no particular limitation as long as it recycles toner removed by the cleaning device to the developing device and can be suitably selected according to a particular application. For example, known conveying devices are suitable.

The recycling process has no particular limit as long as it includes recycling toner removed in the cleaning process to the developing device and can be suitably selected according to a particular application. For example, the recycling process can be conducted by the recycling device.

### Control Device and Control Process

The control device has no particular limitation and any control device as long as it can control the behavior of each device and can be suitably selected to a particular application. For example, devices such as a sequencer and a computer can be used.

The control process has no specific limitation as long as it includes controlling the behavior of each process and can be suitably selected according to a particular application. For example, the control process can be conducted by the control device.

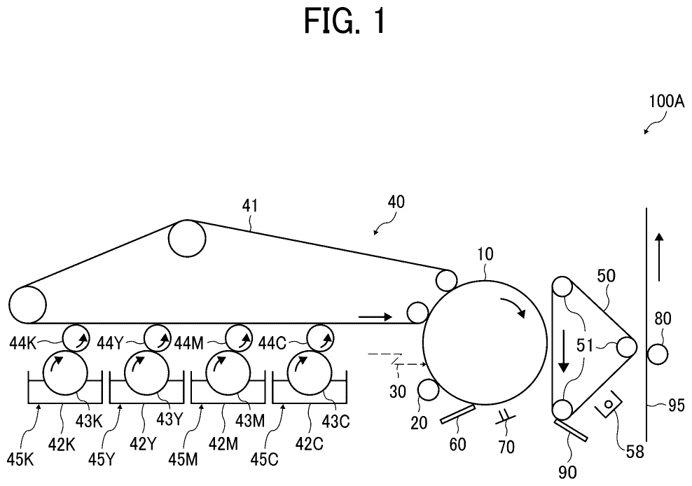

Next, an embodiment of image forming with the electrophotographic image output apparatus related to the present disclosure is described with reference to FIG. 1. An electrophotographic image output apparatus (image forming apparatus) 100A illustrated in FIG. 1 includes a drum photoconductor 10 (hereinafter, also referred to as photoconductor 10) as the electrostatic latent image bearer, a charging roller 20 as the charging device, an irradiator 30 as the exposing device, a developing device 40 as the developing device, an intermediate transfer member 50, a cleaner 60 as the cleaning device having a cleaning blade, and a discharging lamp 70 as the discharging device.

The intermediate transfer member 50 is a belt having an endless form and is designed to be movable in the direction indicated by the arrow by three rollers 51, which are disposed inside the intermediate transfer member 50 and stretches the intermediate transfer member 50. The three rollers 51 partially serves as a transfer bias roller to apply a particular transfer bias (primary transfer bias) to the intermediate transfer member 50. Around the intermediate transfer member 50 is disposed a cleaning device 90 equipped with a cleaning blade. Around the intermediate transfer member 50, a transfer roller 80 is disposed as the transfer device capable of applying a transfer bias to transfer (secondary transfer) a toner image onto a transfer sheet 95 as a recording medium while facing the intermediate transfer member 50. Around the intermediate transfer member 50, a corona charger 58 to apply charges to the toner image on the intermediate transfer member 50 is disposed between the contact portion of the photoconductor 10 and the intermediate transfer member 50 and the contact portion between the intermediate transfer member 50 and the transfer sheet 95 along the rotation direction of the intermediate transfer member 50.

The developing device 40 includes a developing belt 41A as the developing composition bearer, a first developing unit 45K, a second developing unit 45Y, a third developing unit 45M, and a fourth developing unit 45C, all of which are disposed around the developing belt 41. The first developing unit 45K includes a developing composition accommodating unit 42K, a developing composition supplying roller 43K, and a developing roller 44K. The second developing unit 45Y includes a developing composition accommodating unit 42Y, a developing composition supplying roller 43Y, and a developing roller 44Y. The third developing unit 45M includes a developing composition accommodating unit 42M, a developing composition supplying roller 43M, and a developing roller 44M. The fourth developing unit 45C includes a developing composition accommodating unit 42C, a developing composition supplying roller 43C, and a developing roller 44C. Further, the developing belt 41A takes an endless form, stretched around a plurality of belt rollers in a rotatable manner, and partially contacts with the electrostatic latent image bearer 10.

The electrophotographic image output apparatus (transfer medium adhesive image forming apparatus) 100A illustrated in FIG. 1 uniformly charges the drum photoconductor 10 with the charging roller 20, for example. The irradiator 30 irradiates the drum photoconductor 10 imagewise with irradiation light to form an electrostatic latent image. Next, the electrostatic latent image formed on the drum photoconductor 10 is developed using toner supplied from the developing device 40, thereby forming a toner image. The toner image is (primarily) transferred onto the intermediate transfer member 50 by a voltage applied with the roller 51 and then (secondarily) transferred to the transfer sheet 95. As a result, a transfer image is formed on the transfer sheet 95. The residual toner on the drum photoconductor 10 is removed by the cleaner 60, and the charge on the drum photoconductor 10 is temporarily discharged by the discharging lamp 70.

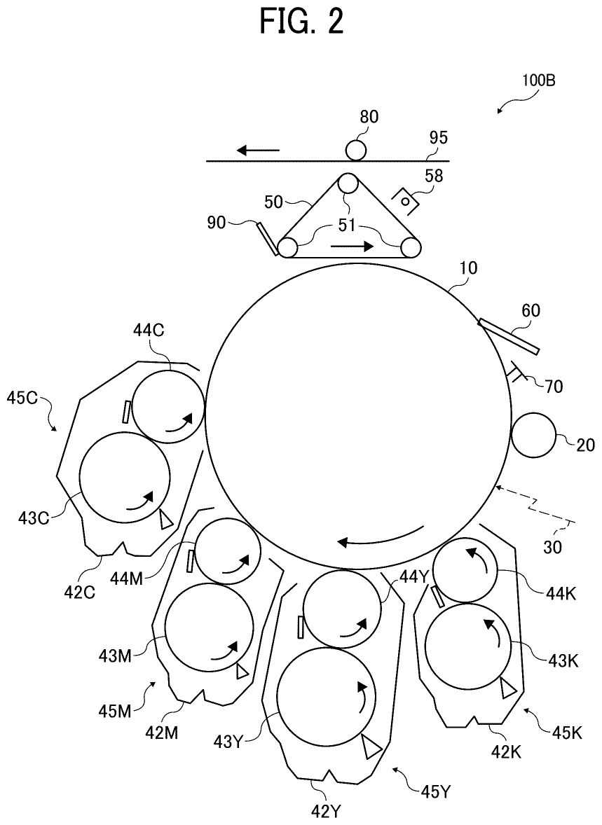

FIG. 2 is a diagram illustrating another example of the image forming apparatus related to the present disclosure. An image forming apparatus 100B has the same configuration as the image forming apparatus 100A illustrated in FIG. 1 except that the first developing unit 45K, the second developing unit 45Y, the third developing unit 45M, and the fourth developing unit 45C are disposed around the drum photoconductor 10 with no developing belt 41 provided.

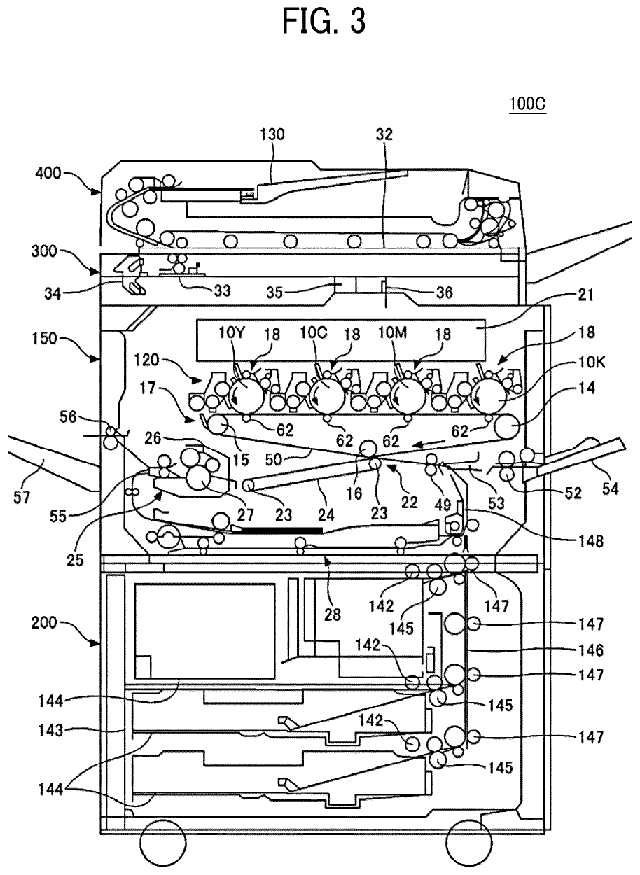

FIG. 3 is a diagram illustrating another example of the image forming apparatus related to the present disclosure. An image forming apparatus 100C illustrated in FIG. 3 includes a photocopying unit 150, a sheet feeding table 200, a scanner 300, and an automatic document feeder (ADF) 400.

The photocopying unit 150 of the image forming apparatus has an intermediate transfer member 50 with an endless belt disposed at the center thereof.

The intermediate transfer member 50 is stretched over support rollers 14, 15 and 16 and rotatable clockwise in FIG. 3. An intermediate transfer member cleaner 17 is disposed around the support roller 15 to remove residual toner on the intermediate transfer member 50. A tandem developing device 120 having four image forming units 18 of first, second, third, and fourth is arranged along the intermediate transfer member 50 stretched over the support rollers 14 and 15. Near the tandem developing device 120, an irradiator 21 is arranged. A secondary transfer device 22 is disposed facing the tandem developing device 120 with the intermediate transfer member 50 therebetween. In the secondary transfer device 22, a secondary transfer belt 24 having an endless form is stretched over a pair of rollers 23. A transfer medium transferred onto the secondary transfer belt 24 can be brought into contact with the intermediate transfer member 50. A fixing device 25 as the fixing device is disposed near the secondary transfer device 22. The fixing device 25 includes a fixing belt 26 having an endless form and a pressure roller 27 pressed against the fixing belt 26.

In addition, if the image forming apparatus is a tandem image forming apparatus, a sheet reversing device 28 for forming images on both sides of the transfer medium by reversing the transfer medium is disposed near the secondary transfer device 22 and the fixing device 25.

Next, the formation of a transfer medium adhesive image using the tandem developing device 120 is described. First, a document (original) is set on a document table 130 on the automatic document feeder 400 or the automatic document feeder 400 is opened to set a document on a contact glass 32 for the scanner 300, and thereafter the automatic document feeder 400 is closed.

When the start button is pressed, the scanner 300 is driven after the original is transferred onto the contact glass 32 in the case where the original is set on the automatic document feeder 400. On the other hand, the scanner 300 is immediately driven in the case where the original is set on the contact glass 32. Then a first scanning unit 33 and a second scanning unit 34 scan the original. Then the original is irradiated with light from the first scanning unit 33. The reflection light from the original is redirected at the mirror of the second scanning unit 34. The redirected light is received by a reading sensor 36 via an image-forming lens 35, whereby the color original is read to obtain image data for the first, second, third, and fourth colors, thereby forming a solid image having the same adhered amount of toner for each color.

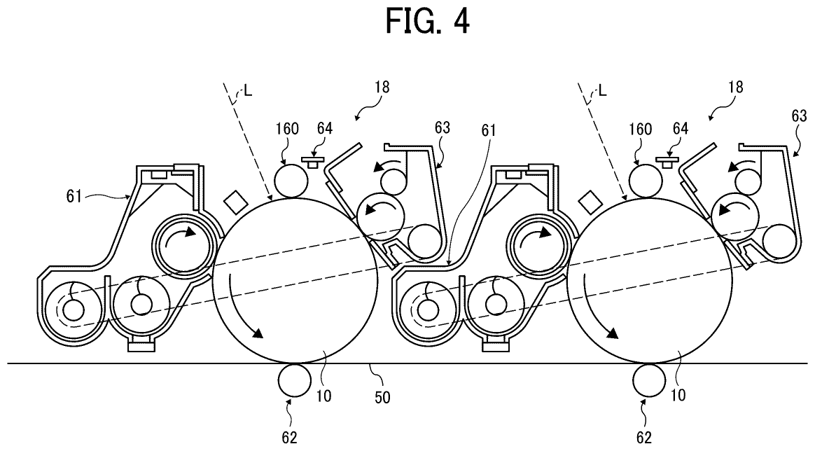

The solid image information is transmitted to each of the image forming units 18 (the first image forming unit, the second image forming unit, the third image forming unit, and the fourth image forming unit) in the tandem developing device 120. Each image forming unit then forms a unified image corresponding to the respective solid image information. That is, as illustrated in FIG. 4, each of the image forming units 18 (the first color image forming unit, the second color image forming unit, the third color image forming unit, and the fourth color image forming unit) in the tandem developing device 120 is provided with: an electrostatic latent image bearer 10 (a first electrostatic latent image bearer 10K, a second electrostatic latent image bearer 10Y, a third electrostatic latent image bearer 10M, and a fourth electrostatic latent image bearer 10C); a charger 160 serving as a charging device for uniformly charging the electrostatic latent image bearer 10; an exposure device that exposes (L in FIG. 4) the electrostatic latent image bearer according to the solid image information to form an electrostatic latent image corresponding to the solid image on the electrostatic latent image bearer; a developing device 61 for developing the electrostatic latent image with each toner for transfer sheets to form a color image with the toner for transfer sheets; a transfer charger 62 for transferring the toner image onto an intermediate transfer member 50; a cleaning device 63; and a charge remover (quencher, discharging member) 64. Each image forming unit 18 forms a monochrome image (a first color image, a second color image, a third color image, and a fourth color image) based on the respective color image information. The first color image, the second color image, the third color image, and the fourth color image thus formed are sequentially transferred (primary transfer) onto the intermediate transfer member 50, which is rotated and conveyed by support rollers 14, 15, and 16. Specifically, the first color image formed on the first electrostatic latent image bearer 10K, the second color image formed on the second electrostatic latent image bearer 10Y, the third color image formed on the third electrostatic latent image bearer 10M, and the fourth color image formed on the fourth electrostatic latent image bearer 10C are sequentially transferred. Consequently, the first color image, the second color image, the third color image, and the fourth color image are transferred onto the intermediate transfer member 50, thereby forming a color image.

At the sheet feeding table 200, one of sheet feeding rollers 142 is selectively rotated to feed a transfer sheet from one of sheet feeding cassettes 144 stacked in a sheet bank 143. The transfer sheet is separated by a separating roller 145 one by one to a sheet feeding path 146. The transfer sheet is guided by conveying rollers 147 to a sheet feeding path 148 in the photocopying unit 150 and halted at registration roller 49. Alternatively, the sheet feeding roller 142 is rotated to bring up the transfer sheets on a bypass tray 54. The transfer sheets are separated one by one with a separating roller 52, conveyed to a manual sheet path 53, and also halted at the registration roller 49. The registration roller 49 is generally grounded but a bias can be applied thereto to remove paper dust on the transfer sheet. The registration roller 49 is rotated in synchronization with the overlapped color composite image (color transfer image) on the intermediate transfer member 50 and feeds the transfer sheet between the intermediate transfer member 50 and the secondary transfer device 22. The overlapped color composite image is secondarily transferred to the transfer sheet. Thus, the color composite image is transferred to and formed on the transfer sheet. The residual toner remaining on the intermediate transfer member 50 after the image transfer is removed with the intermediate transfer member cleaner 17.

The transfer sheet with transferred color image thereon is conveyed to the secondary transfer device 22 and then sent out to the fixing device 25. The fixing device 25 fixes the color composite image on the transfer sheet with heat and pressure. Thereafter, the transfer sheet is directed at a switching claw 55 to an ejection roller 56 for ejecting the transfer sheet to stack it on an ejection tray 57. Alternatively, the transfer sheet is switched at the switching claw 55 to the sheet reversing device 28, which guides the transfer sheet to the transfer position again. Then an image is formed on the other side of the transfer sheet and ejected to the ejection roller 56 to stack it on the ejection tray 57.

### Process Cartridge

The process cartridge relating to the present disclosure is made to be detachably attachable to an image forming apparatus. It includes at least an electrostatic latent image bearer and a developing device that renders the electrostatic latent image visible with a developing composition containing the toner related to the present disclosure to form a toner image. The process cartridge related to the present disclosure may furthermore include other optional devices.

The developing device includes at least a developing composition container for containing a developing composition and a developing composition bearer for bearing and conveying the developing composition in the developing composition container. The developing device may furthermore optionally include a regulating member for regulating the thickness of the developing composition borne on the bearer.

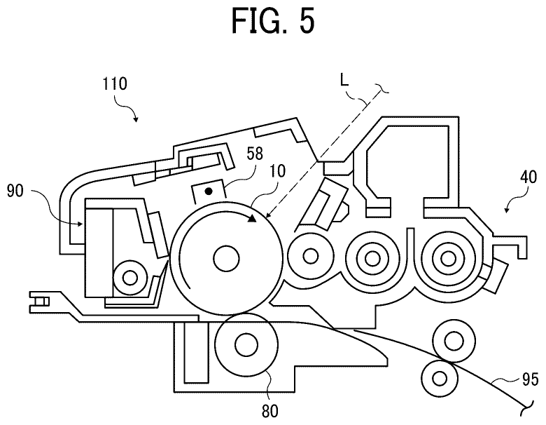

FIG. 5 is a diagram illustrating an example of the process cartridge relating to the present disclosure. The process cartridge 110 includes a drum photoconductor (electrostatic latent image bearer) 10, a corona charger 58, a developing device 40, a transfer roller 80, and a cleaning device (cleaner) 90.

### Thermal Transfer Device

The thermal transfer device thermally transfers a thermal transfer print sheet onto a transfer medium such as cloth or leather, and is capable of applying heat for a predetermined period of time under uniform pressure across the press surface. Such a device is also referred to as an iron press machine or a heat press machine.

The thermal transfer device used in the present disclosure may be any commercially available device.

For producing articles such as T-shirts, the area of the press surface is preferably larger than the area of the transfer medium. Uniform heat and pressure across the entire surface of the transfer medium allow formation of a transferred image free from press marks.

Specific examples include, but are not limited to, GFH-380 and GHP-300 (System Graphi Co., Ltd.), HPT234PS1, HSP-5400, HP-4536A-12, HP-54A, HP-84A, HSP-1513PV-AT, and HSP-1010 (HASHIMA), TS-ONE (Sister), TP630M and TP700A (Horizon).

In thermal transfer, the temperature varies depending on the material and thickness of the transfer medium. It is preferably higher than the softening point Ts of the transfer-medium adhesive toner and is preferably Th-20 degrees Celsius, where Th is the heat-resistance temperature of the transfer medium.

The pressure is preferably low as long as transfer can be achieved, preferably at most 1000 g/cm², more preferably at most 600 g/cm², and even more preferably at most 300 g/cm².

A commercially available household iron may also be used. However, it becomes difficult to apply heat uniformly and at a constant pressure.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

Hereinafter, the present disclosure is described in more detail based on Examples, but the technical scope of the present disclosure is not limited to thereto.

“Parts” represents parts by mass and “percent” represents percent by mass unless otherwise specified in the following description.

The material names used in each Example and Comparative Example are shown in Table 1 below.

TABLE 1

| | |
|---|---|
| Resin A | (ECOFREEN POWDER, manufactured by ECOFREEN; |
| | softening point: 125 degrees Celsius; glass transition |
| | temperature: −29 degrees Celsius) |
| Resin B | Polyurethane elastomer |
| | (E780M128, manufactured by Nihon Miractran Co., Ltd.; |
| | softening point: 121 degrees Celsius; glass transition |
| | temperature: −24 degrees Celsius) |
| Resin C | Polyurethane elastomer |
| | (571F, manufactured by BASF; softening point: 114 degrees |
| | Celsius; glass transition temperature: −46.5 degrees Celsius) |
| Resin D | Polyester resin |
| | (RN-306SF, manufactured by Kao Corporation; softening |
| | temperature: 100 degrees Celsius; glass transition |
| | temperature: 60 degrees Celsius) |
| Material A | Ester wax (LW-13, manufactured by Sanyo Chemical |
| | Industries, Ltd.) |
| Material B | Titanium oxide white pigment (PF-739, manufactured by |
| | Ishihara Sangyo Kaisha, Ltd.) |
| Material C | Carbon black (#44, manufactured by Mitsubishi Chemical |
| | Corporation) |
| Material D | Fluorescent whitening agent (Tinopal OB, manufactured by |
| | BASF Japan Ltd.) |

### Manufacturing of Toner Thermal Transfer Print Sheet

Raw toners 1 to 4 were obtained according to the prescriptions shown in Table 2 below.

TABLE 2

| | | Raw | Raw | Raw | Raw |
|---|---|---|---|---|---|
| | | toner 1 | toner 2 | toner 3 | toner 4 |
| Resin A | Polyurethane | 48 | | | 66 |
| Resin B | Polyurethane | | 48 | 40 | |
| Resin C | Polyurethane | | | 18 | |
| Resin D | Polyester resin | 23 | 23 | 28 | 30 |
| Material A | Ester wax | 4 | 4 | 4 | 4 |
| Material B | Titanium oxide | 25 | 25 | | |
| | white pigment | | | | |
| Material C | Carbon black | | | 10 | |
| Material D | Fluorescent | | | | 0.1 |
| | whitener | | | | |

The above raw toner 1 was subjected to pulverization and classification under various pulverization and classification conditions to obtain toners 1 to 3, 7, and 8 shown in Table 3 below.

In addition, the raw toners 2 to 4 were pulverized and classified to obtain toners 4 5 to 6 shown in Table 3 below.

TABLE 3

| | | Toner | |
|---|---|---|---|
| | | particle | |
| | Material | diameter | |
| Toner No. | toner No. | (μm) | Note |
| Toner 1 (white) | Raw toner 1 | 18 | Raw toner 1 was |
| Toner 2 (white) | Raw toner 1 | 11 | pulverized and |
| Toner 3 (white) | Raw toner 1 | 26 | classified to adjust |
| | | | its particle size. |
| Toner 4 (white) | Raw toner 2 | 18 | Raw toners 2 to 5 were |
| Toner 5 (black) | Raw toner 3 | 18 | pulverized and |
| Toner 6 (clear) | Raw toner 4 | 18 | classified to adjust |
| Toner 7 (white) | Raw toner 1 | 8 | their particle size |
| Toner 8 (white) | Raw toner 1 | 33 | to be 18 μm. |
| | | | Raw toner 1 was |
| | | | pulverized and |
| | | | classified to adjust |
| | | | its particle size. |

The raw materials of toner 1 were first pre-mixed using a Henschel mixer (FM20B, manufactured by Nippon Coke & Engineering Co., Ltd.).

The resulting mixture was then melt-kneaded at 90 degrees Celsius using a batch-type kneader (Wonder Kneader WDS7-30, manufactured by Moriyama Mfg. Works, Ltd.). The resulting kneaded mixture was extruded through a 3 mm diameter die using a feeder-loader to form strands, which were cooled in a water bath maintained at 15 degrees Celsius or lower. The cooled and solidified strands were then cut with a pelletizer to obtain Toner Pellet 1, each having a diameter and length of 2 mm.

These pellets constitute the coarsely pulverized product of the toner component melt-kneaded material.

Next the pellets were cooled using a liquid-nitrogen cooling device and subsequently pulverized with a mechanical pulverizer (Linx Mill LX, manufactured by Hosokawa Micron Corporation). The pulverized material discharged from the pulverizer was sieved through a 25 μm mesh. The portion that did not pass through the mesh was returned to the pulverizer, and the fine particles that passed through the 25 μm mesh were collected.

After the 25-mesh pass-through fine particles were returned to room temperature, the particles were classified using an air classifier (EJ-LABO, manufactured by MATSUBO Corporation) while appropriately adjusting the louver opening so that the toner median particle diameter became 18 μm, thereby obtaining toner base particles 1.

Then 1.0 part by mass of additive 1 (silica, HDK-2000, manufactured by Clariant AG) and 1.0 part by mass of additive 2 (silica, H05TD, manufactured by Clariant AG) were mixed and agitated with 100 parts by mass of the obtained toner base particles 1 using a HENSCHEL MIXER, thereby preparing toner 1 for thermal transfer print sheets.

Toners 2 to 8 for thermal transfer print sheets were manufactured in the same manner.

### Preparation of Carrier

### Raw Material of Carrier

IP solvent: 710 parts by mass
ECF-800:220 parts by mass (manufactured by Titanium Industry Co., Ltd.; mixed fine particles of aluminum oxide, stannic acid, and phosphorus pentoxide)
R5T: 40 parts by mass (manufactured by Toray Dow Corning Co., Ltd.; silicon-acrylic resin in toluene solution)
RCF-2130:400 parts by mass (manufactured by Toray Dow Corning Co., Ltd.; polyalkenylsiloxane in toluene solution)
CTC-754:45 parts by mass (manufactured by Matsumoto Fine Chemical Co., Ltd.; titanium isopropoxide bis(ethyl acetate))
RSH-602:5 parts by mass (manufactured by Toray Dow Corning Co., Ltd.; Y-(2-aminoethyl)aminopropyltrimethoxysilane)

These materials specified above were dispersed using a Homomixer for 20 minutes to prepare a resin layer coating solution. Using a fluidized-bed coating device, the above resin layer coating solution was applied to 7,200 parts by mass of spherical manganese-magnesium ferrite having an average particle diameter of 70 μm, thereby producing a carrier.

### Manufacturing of Developing Composition

Using a ball mill, 7 parts by mass of each of toners 1 to 8 for thermal transfer printing and 93 parts by mass of the carrier were separately mixed to prepare the respective developing compositions. Next, images were formed on thermal transfer print sheets using the respective developing compositions.

### Printing on Thermal Transfer Print Sheet

To prepare an image sheet, the developing composition corresponding to Toner 6 were loaded into all process-color stations of a modified RICOH Pro C7100 (four-station configuration), and the development amount was adjusted so that the thickness of the printed layer became 25 μm. The resulting image was then printed and fixed on Thermal Transfer Print Sheet A.

Next, a desired image was printed on Thermal Transfer Print Sheet A using a RICOH Pro C7200S (five-station configuration). In this step, a black toner for the RICOH Pro C7200S was used, and the printing conditions were adjusted such that the image layer had a thickness of approximately 4 μm. The printed image was fixed to obtain Thermal Transfer Print Sheet B. Further, the developing composition corresponding to Toner 1 were loaded into all process-color stations of the modified RICOH Pro C7100 (four-station configuration), and the development amount was adjusted so that the thickness of the adhesive layer became 45 μm. Printing and fixing were then performed on Thermal Transfer Print Sheet B.

Although the printing conditions, including the number of passes, may be arbitrarily selected to achieve the required layer thickness, in Example 1 the conditions were set to one pass, since it was confirmed that one pass was sufficient. Thermal Transfer Print Sheet C was thus prepared. The magnification of the layer thickness was evaluated at this stage. Fixability at this stage was also evaluated.

However, in Example 9, an image layer having a thickness of 2 μm was formed using a commercially available inkjet printer.

The obtained Thermal Transfer Print Sheet C was placed on a black T-shirt (United Athle, 4.7-ounce Dry Silky Touch T-shirt, low-bleed type) together with a heat press machine (Model HTP234PS1, manufactured by Piotec). Heat and pressure were applied at 130 degrees Celsius for 20 seconds and 300 g/cm². After that, the transfer sheet was peeled off to transfer and fix the color image onto the T-shirt.

Subsequently, a release paper was placed on the image, and heat and pressure at 130 degrees Celsius and 300 g/cm² were again applied for 20 seconds. The release paper was then peeled off to complete the printed T-shirt.

Using this T-shirt, fixability, image reproducibility, and rubbing fastness were evaluated.

### Fixability

The printed T-shirts obtained under each condition were evaluated for color fading, peeling, and image cracking. The results are shown in Table 4 below.

A T-shirt was rated as A when no issues were observed, and rated as C when any color fading, peeling, or cracking was observed, even partially.

### Image Reproducibility

Image reproducibility with respect to differences in the lightness of the transfer target was evaluated by comparing the image printed on a white T-shirt with the image printed on a black T-shirt.

If the image obtained on the white T-shirt could also be reproduced on the black T-shirt, the result was rated as A.

When the difference between the chroma values c*w of the red and blue portions on the white T-shirt and the chroma values c*b on the black T-shirt was:
less than 3 rated as S
3 to less than 5 rated as A
5 or more rated as C
Evaluations rated A or B were regarded as acceptable for practical use.

### Rubbing Fastness

Rubbing fastness was evaluated using a Type II friction tester (Gakushin-type friction tester) specified in the rubbing fastness test of JIS L 0849 (Test methods for colour fastness to rubbing).

An image-forming substrate, cut to a length of 100 mm, was fixed onto the surface of the Type II friction tester. A piece of cotton fabric was attached to the tester so that a load of approximately 200 g was applied to the surface of the image-forming substrate.

The cotton fabric was then slid back and forth over a stroke length of 100 mm for 100 cycles while maintaining the load of approximately 200 g on the substrate.

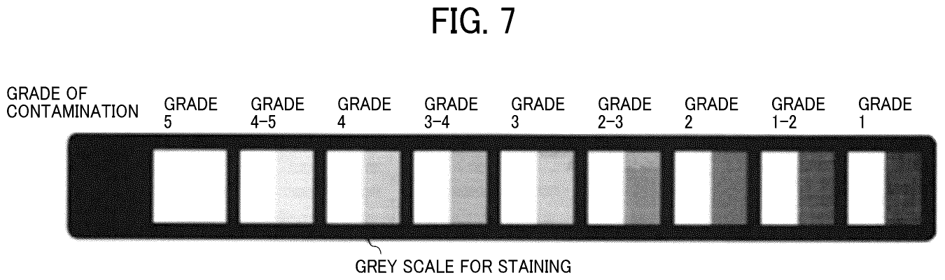

After the test, the cotton fabric was removed from the tester, and the degree of “staining” was evaluated using a grey scale for staining as illustrated in FIG. 7.

The rubbing fastness value was determined based on this staining evaluation and was rated in accordance with the following evaluation criteria.

### Evaluation Criteria

S: Staining grade 4 to 5 or higher
A: Staining grade 4
B: Staining grade 3
C: Staining grade below 3

The evaluation results described above are shown in Table 4 below.

TABLE 4

| | Clear layer | | Image Layer | | Adhesive layer | |
|---|---|---|---|---|---|---|
| | | Layer | | Layer | | Layer |
| | | thickness | | thickness | | thickness |
| | Toner | (μm) | Toner | (μm) | Toner | (μm) |
| Example 1 | Toner 6 | 25 | Color | 4 | Toner 1 | 45 |
| Example 2 | Toner 6 | 26 | Color | 4 | Toner 2 | 40 |
| Example 3 | Toner 6 | 25 | Color | 4 | Toner 3 | 51 |
| Example 4 | Toner 6 | 24 | Color | 4 | Toner 4 | 45 |
| Example 5 | Toner 6 | 25 | Color | 4 | Toner 5 | 46 |
| Example 6 | Toner 6 | 25 | Color | 4 | Toner 1 | 28 |
| Example 7 | Toner 6 | 27 | Color | 4 | Toner 1 | 98 |
| Example 8 | Toner 6 | 44 | Color | 4 | Toner 1 | 101 |
| Example 9 | Toner 6 | 26 | Ink | 2 | Toner 1 | 44 |
| Comparative | None | — | Color | 4 | Toner 1 | 46 |
| Example 1 | | | | | | |
| Comparative | Toner 6 | 4 | Color | 4 | Toner 1 | 45 |
| Example 2 | | | | | | |
| Comparative | Toner 6 | 26 | Color | 4 | Toner 1 | 19 |
| Example 3 | | | | | | |
| Comparative | Toner 6 | 26 | Color | 4 | Toner 8 | 17 |
| Example 4 | | | | | | |
| Comparative | Toner 6 | 26 | Color | 4 | Toner 9 | 66 |
| Example 5 | | | | | | |

| | | | | Image | |
|---|---|---|---|---|---|
| | Magnification | | | Reproduc- | Rubbing |
| | of layer | | Fixability | ibility | fastness |
| Example 1 | 1.80 | A | A | A | S |
| Example 2 | 1.54 | A | A | A | A |
| Example 3 | 2.04 | A | A | A | S |
| Example 4 | 1.88 | A | A | A | S |
| Example 5 | 1.84 | A | A | A | S |
| Example 6 | 1.12 | A | A | A | A |
| Example 7 | 3.63 | A | A | A | S |
| Example 8 | 2.30 | A | A | A | B |
| Example 9 | 1.69 | A | A | A | S |
| Comparative | — | C | A | A | C |
| Example 1 | | | | | |
| Comparative | 11.25 | B | A | A | C |
| Example 2 | | | | | |
| Comparative | 0.73 | C | A | C | A |
| Example 3 | | | | | |
| Comparative | 0.65 | C | A | C | A |
| Example 4 | | | | | |
| Comparative | 2.54 | A | A | C | A |
| Example 5 | | | | | |

Some embodiments of the present disclosure are described above, these embodiments are described for illustration purpose only, and the present invention is not limited thereto. It is to be noted that the above-specified embodiments are not limiting the present disclosure and any deletion, addition, modification, change, etc. Can be made within a scope in which man in the art can conceive including other embodiments, and any of which is included within the scope of the present disclosure as long as the effect and feature of the present disclosure are demonstrated.

Also, various combinations, omissions, replacement, and alterations can be conducted within the scope of the effects of the present invention. Such embodiments and variations are within the scope and effect of the present invention and are included in the invention described in the scope of the claims and their equivalents.

The aspects of the present disclosure are, for example, as follows:

### Aspect 1

A method of producing a thermal transfer print sheet includes forming, on a transfer sheet, a clear layer having a thickness of at least 5 μm with a clear toner containing a thermoplastic elastomer and polyester, forming, on the clear layer, an image layer containing a colorant, and forming, on the image layer, an adhesive layer thicker than the clear layer with a black toner containing a thermoplastic elastomer, polyester, and carbon black and having a volume average particle diameter of 9 to 30 μm or a white toner containing a thermoplastic elastomer, polyester, and a white pigment and having a volume average particle diameter of 9 to 30 μm.

### Aspect 2

The method according to Aspect 1 mentioned above, wherein each of the black toner and the white toner has a volume average particle diameter of 10 to 25 μm.

### Aspect 3

The method according to Aspect 2 mentioned above, wherein each of the clear toner, the black toner, and the white toner is separately combined with a magnetic carrier having a volume average particle diameter of 50 to 80 μm.

### Aspect 4

A thermal transfer print sheet includes a transfer sheet, a clear layer on the transfer sheet, the clear layer having a thickness of at least 5 μm and containing a thermoplastic elastomer and a polyester, an image layer on the clear layer, the image layer containing a colorant, and an adhesive layer on the image layer, the adhesive layer being thicker than the clear layer and containing a black toner containing a thermoplastic elastomer, a polyester, and a carbon black or a white toner containing a thermoplastic elastomer, a polyester, and a white pigment.

### Aspect 5

The thermal transfer print sheet according to Aspect 4 mentioned above, wherein the adhesive layer is at least 1.5 times thicker than the clear layer.

### Aspect 6

A method of thermal transfer printing includes stacking the thermal transfer print sheet of claim 4 on a transfer medium with the adhesive layer facing the transfer sheet, heating and pressing the thermal transfer print sheet with a heat pressing machine, cooling the thermal transfer print sheet and peeling off the transfer sheet to thermally-transfer the adhesive layer, the image layer, and the clear layer to the transfer medium.

### Aspect 7

The method according to Aspect 6 mentioned above, wherein the transfer medium includes a garment made of cotton, polyester, nylon, rayon, silk, or a composite fiber thereof.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. A method of producing a thermal transfer print sheet, comprising:
forming, on a transfer sheet, a clear layer having a thickness of at least 5 μm with a clear toner containing a thermoplastic elastomer and polyester;
forming, on the clear layer, an image layer containing a colorant; and
forming, on the image layer, an adhesive layer thicker than the clear layer with a black toner containing a thermoplastic elastomer, polyester, and carbon black and having a volume average particle diameter of 9 to 30 μm or a white toner containing a thermoplastic elastomer, polyester, and a white pigment and having a volume average particle diameter of 9 to 30 μm.

2. The method according to claim 1, wherein each of the black toner and the white toner has a volume average particle diameter of 10 to 25 μm.

3. The method according to claim 2,
wherein each of the clear toner, the black toner, and the white toner is separately combined with a magnetic carrier having a volume average particle diameter of 50 to 80 μm.

4. A thermal transfer print sheet comprising:
a transfer sheet;
a clear layer on the transfer sheet, the clear layer having a thickness of at least 5 μm and containing a thermoplastic elastomer and a polyester;
an image layer on the clear layer, the image layer containing a colorant; and
an adhesive layer on the image layer, the adhesive layer being thicker than the clear layer and containing a black toner containing a thermoplastic elastomer, a polyester, and a carbon black or a white toner containing a thermoplastic elastomer, a polyester, and a white pigment.

5. The thermal transfer print sheet according to claim 4, wherein the adhesive layer is at least 1.5 times thicker than the clear layer.

6. A method of thermal transfer printing comprising:
stacking the thermal transfer print sheet of claim 4 on a transfer medium with the adhesive layer facing the transfer sheet;
heating and pressing the thermal transfer print sheet with a heat pressing machine;
cooling the thermal transfer print sheet; and
peeling off the transfer sheet to thermally-transfer the adhesive layer, the image layer, and the clear layer to the transfer medium.

7. The method according to claim 6,
wherein the transfer medium comprises a garment made of cotton, polyester, nylon, rayon, silk, or a composite fiber thereof.
